(19) United States
(12) Patent Application Publication
(10) Pub. No.: US 2005/0026528 A1
(43) Pub. Date: Feb. 3, 2005

(54) Fire resistant fabric composite, process for fire-blocking a mattress and mattress set, and a mattress and mattress set fire-blocked thereby

(76) Inventors: Herman Hans Forsten, Williamsburg, VA (US); Warren F. Knoff, Richmond, VA (US); William E. Younts III, Fort Mill, SC (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/630,081

(22) Filed: Jul. 29, 2003

(51) Int. Cl. D04H 1/00; B27N 9/00; A47C 17/00; B32B 5/24; B32B 5/18; D04H 13/00; D04H 5/00; D04H 3/00

(52) U.S. Cl. 442/414; 442/370; 442/373; 442/416; 5/698; 5/954; 428/921

(57) ABSTRACT

This invention relates to a fabric composite for use in fire-blocking a mattress, a fire-blocked mattress set, and a process for fire-blocking mattresses; the fabric composite comprising, in order, (a) sacrificial outer ticking, (b) sacrificial cushioning material, and (c) fire-blocking fabric, the fire-blocking fabric being a single layer of nonwoven fabric comprising at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per square meter) of a heat-resistant fiber. Mattress sets fire-blocked with this fabric composite have a peak heat release rate of less than 150 kilowatts within 30 minutes, preferably less that 150 kilowatts within 60 minutes, and a total heat release of less than 25 megajoules within 10 minutes when tested according to Technical Bulletin 603 of the State of California.

### BACKGROUND OF THE INVENTION

1. Field of the Invention

This invention relates to a fabric composite for use in fire-blocking a mattress, a fire-blocked mattress set, and a process for fire-blocking mattresses. Such mattress sets have a peak heat release rate of less than 150 kilowatts within 60 minutes and a total heat release of less than 25 megajoules within 10 minutes when tested according to Technical Bulletin 603 of the State of California.

2. Description of Related Art

The State of California has led the drive to regulate and reduce the flammability of mattresses and mattress sets in an attempt to reduce the number of lives lost in household, hotel, and institutional fires. In particular, the Bureau of Home Furnishings and Thermal Insulation of the Department of Consumer Affairs of the State of California issued Technical Bulletin 603 “Requirements and Test Procedure for Resistance of a Residential Mattress/Box Spring Set to a Large Open-Flame” to quantify the flammability performance of mattress sets.

Mattresses normally contain a mattress core covered by a cushioning material that is in turn covered with an outer fabric ticking. Most cushioning material is made from foam or fiber materials that will burn when exposed to an open flame. One useful method of fire-blocking foam cushions, particularly airplane seats, is disclosed in U.S. Pat. No. 4,750,443 to Blaustein, et al., wherein three to seven layers of flame resistant fabrics are used underneath the covering fabric of the seat to encase the foam. To the degree required per the aircraft seat flammability test method, these fire-blocked cushions withstand a flame jet impinging on the cushion and prevent the entire cushion from being engulfed by the flame or continuing to burn after the flame jet is removed.

U.S. Pat. Nos. 6,132,476; 6,547,835; and 5,609,950 disclose fabric blends of inherently flame resistant fibers and cellulosic fibers having increased flame resistance; the fabric can contain an additional fire retardant that is added, for example, as an additive in a dyeing step. Because of the low content of inorganic material the flame resistant cellulose fiber disclosed in these references does not retain an adequate percentage of their fiber weight when exposed to high temperatures.

Mattresses are sold by a consumer's initial impression of support and comfort and, therefore, mattresses normally contain, in addition to any supporting foam in the mattress core, cushioning material made from light density fibrous battings or foams, or a combination of both, that provide a surface cushioning effect. This tactile cushioning effect is highly desired by the consumer. The cushioning material is normally stitched and acts like a pillow above the mattress core, providing very tactile cushioning, the type that can be readily discerned by simply touching or running one's hand across the mattress. Attempts to encase all the flammable materials in a mattress with a fire-blocking fabric in a manner similar to that used for airplane seats, that is, by inserting appropriate fire-blocking layers underneath the ticking to encase all the battinging and/or the foam, compress and restrain the cushioning material and severely limit the cushioning effect, giving the mattress poor initial tactile aesthetics. In addition, the use of multiple fire-blocking layers can also add stiffness or restrain the give of the mattress core, affecting overall comfort. Therefore, what is needed is a way to fire-block a mattress while retaining excellent initial aesthetics of the mattress, including the tactile aesthetics of the cushioning material.

### SUMMARY OF THE INVENTION

This invention is related to a fabric composite resistant to an open flame comprising, in order, sacrificial outer ticking, sacrificial cushioning material, and fire-blocking fabric, the fire-blocking fabric being a single layer of nonwoven fabric comprising at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per square meter) of a heat-resistant fiber. In one embodiment of this invention, the cellulose fiber is a viscose fiber containing silicic acid, and the heat-resistant fiber is a poly(paraphenylene terephthalamide fiber, and the viscose fiber (X) and heat resistant fiber (Y) are present in the fire-blocking fabric in a weight ratio expressed by the equation:
Y>/=−0.14X+1.4.

This invention is also related to a mattress set resistant to an open flame comprising a mattress and a mattress foundation: the mattress comprising a fabric composite and a mattress core, the fabric composite comprising in order: i) sacrificial outer ticking, ii) sacrificial cushioning material, and iii) a single layer nonwoven fire-blocking fabric, and the mattress foundation comprising a single layer nonwoven fire-blocking fabric and a support structure, wherein the mattress set has a peak heat release rate of less than 150 kilowatts within 30 minutes and a total heat release of less than 25 megajoules in the first 10 minutes when tested according to Technical Bulletin 603 of the State of California. In one embodiment, the mattress set has a peak heart release rate of less than 150 kilowatts within 60 minutes and a total heat release of less than 25 megajoules in the first 10 minutes when tested according to Technical Bulletin 603 of the State of California.

This invention is also related to a process for fire-blocking a mattress having, in order, ticking, cushioning material, and a mattress core, the process comprising incorporating into the mattress a fire-blocking fabric between the cushioning material and the mattress core; the fire-blocking fabric being a single layer of nonwoven fabric comprising least 0.5 ounce per square yard (17 grams per square meter) of a cellulose fiber that retains at least 10 percent of its fiber weight when heated in air to 700 C at a rate of 20 degrees C. per minute and at least 0.5 ounces per square yard (17 grams per square meter) of a heat-resistant fiber.

### BRIEF DESCRIPTION OF THE DRAWINGS

FIG. 1 illustrates, in a simplified manner, the fabric composite of this invention.

FIG. 2 illustrates a range of compositions for the fire-blocking fabric used in this invention.

FIG. 3 illustrates a preferred range of compositions for the fire-blocking fabric used in this invention.

FIG. 4 illustrates a simplified cross section of the fire-blocked mattress of this invention.

FIG. 5 illustrates a cut-away view of the fire-blocked mattress of this invention, showing in a simplified manner the fabric composite, cushioning foam, and mattress internals.

FIG. 6 illustrates a simplified cross section of one possible embodiment of a fire-blocked foundation of this invention.

FIG. 7 illustrates a simplified cross section of one possible embodiment of a fire-blocked foundation of this invention having a different fabric top face.

FIG. 8 illustrates, in a simplified manner, the arrangement of burners, the mattress and foundation used to test the burn performance of a mattress and mattress set of this invention.

FIG. 9 illustrates, in a simplified manner, the offset of the arrangement of burners used to burn the mattress and mattress set of this invention.

### DETAILS OF THE INVENTION

This invention is directed to fabric composite for use with mattresses. This fabric composite allows for various external surface affects to be created for the mattress, such as a quilted pillow surface or other soft, deformable surface, which insures the mattress of this invention has essentially the same feel to the touch as a mattress not containing a fire-blocking layer.

This invention is also directed to a fire-blocked mattress that incorporates the fabric composite. The fabric composite comprises, in order, outer fabric ticking, cushioning material, and fire-blocking fabric. The term sacrificial fabric as employed in conjunction with sacrificial outer ticking and sacrificial cushioning material denotes the ability of the fabric to burn when exposed to a flame. Although a fire-retardant chemical may be introduced in a sacrificial fabric, such incorporation is not necessary. The ticking and cushioning material become sacrificial layers if the mattress is burned. That is, they are allowed to burn when the mattress is exposed to a flame. The inventors of the present invention have found that such materials may be allowed to bum as long as the quantity of the available fuel contributed by the ticking and cushioning material is limited and the fire-blocking fabric is constructed of appropriate materials. The fire-blocking fabric performs certain functions when the mattress set is burned, including (1) protecting the mattress core along with any foams therein from the impinging flame and the burning batting and ticking, and (2) resisting the propagation of the flame along the surface of the mattress. The actual construction technique for the fabric composite is not critical as long as the materials are assembled in order with the ticking on the outside, the cushioning material in the center and then the fire-blocking fabric. Preferably, the fabric composite can be made in a separate step and then placed over and attached to the mattress core, however, it is also possible that the individual layers may be placed separately over the mattress core and assembled on the mattress core.

This invention is further directed to a mattress set resistant to an open flame comprising a mattress and a mattress foundation wherein the mattress includes a fabric composite and a mattress core, the fabric composite comprising, in order, a sacrificial outer ticking, a sacrificial cushioning material, and a single layer nonwoven fire-blocking fabric. The mattress foundation can also include the fabric composite. The mattress set has a peak heat release rate of less than 150 kilowatts within the first 30 minutes of the test, and preferably less than 150 kilowatts within the first 60 minutes of the test, when tested according to Technical Bulletin 603 of the State of California. Additionally, the mattress set has a total heat release of less than 25 megajoules within 10 minutes when tested according to Technical Bulletin 603.

Fabric Composite

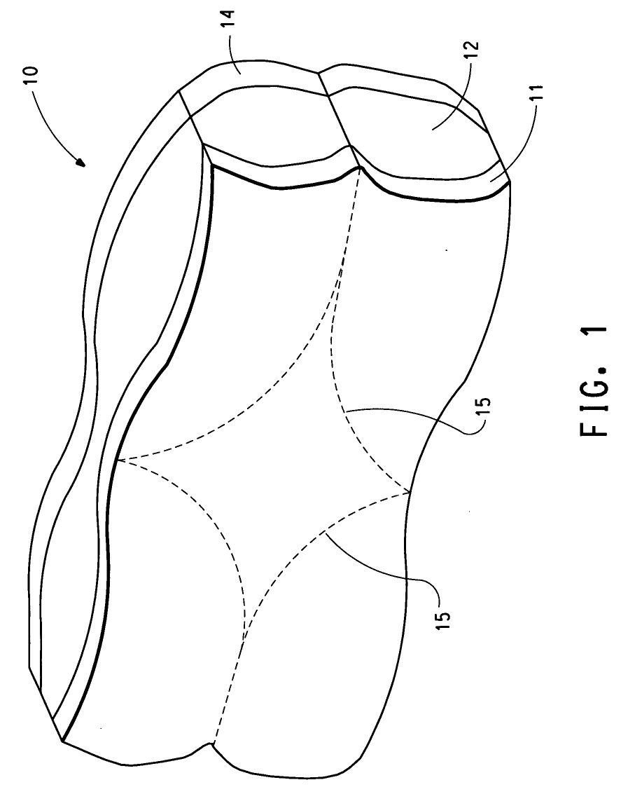

FIG. 1 is a simplified representation of a cutout of the fabric composite of this invention with the individual parts not drawn to scale but expanded for clarity. Fabric composite 10 is shown with ticking 11 combined with cushioning material 12. Adjacent to the cushioning material is fire-blocking fabric 14. This figure illustrates a quilt-type pattern with stitches 15 forming a pillowed surface in the ticking and cushioning material.

Sacrificial Ticking

The outer surface of the fabric composite 10 is covered by ticking 11. Such fabrics are normally very durable woven or knit fabrics utilizing any number of weaves, and tend to have basis weights in the range of 2 to 8 ounces per square yard (68 to 271 grams per square meter). Typical ticking fabrics may contain but are not limited to cotton, polyester fibers, or rayon fibers. The ticking is normally stitched to the cushioning material and the fire-blocking fabric, making quilt-like areas to create pillow-like projections on the outer face of the fabric composite or mattress. In addition, the seams of ticking and/or the fabric composite at the edges of the mattress may be taped and sewn to provide addition seam strength at these areas. It is preferred that the sewing thread used to stitch the ticking at the seams and the material used in the edge tapes be made from a flame resistant material. The preferred flame resistant material for stitching is an aramid thread made from aramid fiber and the preferred aramid is poly(paraphenylene terephthalamide).

Sacrificial Cushioning Material

The fabric composite 10 of this invention contains a cushioning material 12 to provide additional initial comfort. This cushioning material is in addition to any supporting foam in the mattress core. The cushioning material may include one or more light density fibrous batting or foams, or a combination thereof that provide the surface effect that is highly desired by the consumer. The batting and/or foams acts like a pillow underneath the ticking, providing very tactile cushioning, the type that can be readily discerned by simply touching or running one's hand across the mattress. While not intended to be limiting, if the cushioning material is a fibrous batting, such batting may include a vertically pleated structure as disclosed in, for example, in PCT Publication WO 2003049581 or a batting of fibers as disclosed for example in U.S. Pat. No. 3,118,750.

The cushioning material adds potential fuel to the fabric composite and the maximum allowable basis weight of the cushioning material used in the fabric composite depends on a number of parameters. The heat of combustion of the cushioning material and the burn rate are the most critical of these parameters. For typical polyester (PET) batting widely used in the bedding industry, the heat of combustion is about 21.6 megajoules per kilogram (page V/113 “Handbook of Polymers” Fourth Edition, John Wiley & Sons, Inc. 1999). For a standard twin size mattress the top panel is about 2.4 square yards (2.6 square meters), and the total heat of combustion from a 1 ounce per square foot (305 grams per square meter) polyester batting on that top panel is about 13.25 megajoules. The burn pattern on the top panel typically radiates outward from the location of the burner at a rate at which the cushioning layer on the top panel is completely consumed within the first 30 minutes of the test. The above observations and facts lead to a simple model of heat release in which the heat release rate starts at approximately zero and increases linearly with time. Within these assumptions, the following table can be calculated.

TABLE 1
Computed Heat Release for Polyester Batting in Mattresses

| PET Basis | | THR at 10 | THR at 30 |
|---|---|---|---|
| weight oz/ft² | PHRR, kW | min, MJ | min, MJ |
| 1 | 14.8 | 1.5 | 13.3 |
| 2 | 29.5 | 2.9 | 29.5 |
| 4 | 59.0 | 5.9 | 53.0 |
| 6 | 88.5 | 8.8 | 88.5 |
| 10 | 147.6 | 14.7 | 132.5 |
| 12 | 177.1 | 17.7 | 159.1 |

PHRR - Peak Heat Release Rate
THR - Total Heat Release

Table 1 shows that, in the absence of all other sources of heat, the maximum allowable basis weight of a typical cushioning layer is around 10 oz/yd² (339 g/m²). This corresponds to a total heat of combustion of 130 MJ/yd² (155 MJ/m²). Above this value the peak heat release rate is predicted to exceed the 150 kW allowable maximum. Therefore, the total combined heat of combustion of the sacrificial cushioning layer and any ticking should not exceed about 130 MJ/yd² (155 MJ/m²). While fiber batting has been used as an example, the same total combined heat of combustion would apply if the cushioning layer was foam or a combination of foam and fiber batting.

Fire-Blocking Fabric

The fire-blocking fabric positioned underneath the ticking and cushioning material is a single layer nonwoven fabric preferably comprised of at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per square meter) of heat resistant fiber. The nonwoven fire-blocking fabric used in this invention has a basis weight of at least 2.5 ounces per square yard (85 grams per square meter). Single layer nonwoven fabrics having basis weights of less than that amount do not provide adequate fire-blocking performance. The maximum practical basis weight of the nonwoven fire-blocking fabric of this invention is in the range of 7 ounces per square yard. Heavier weight fabrics still provide protection, however, with additional basis weight there is little improvement in fire retarding performance. Nonwoven fabrics having this composition and basis weight can be used as the sole fire-blocking component for a mattress or a mattress set comprising a mattress and foundation.

The nonwoven fire-blocking fabric can be made by conventional nonwoven sheet forming processes, including processes for making air-laid nonwovens or wet-laid nonwovens, and such formed sheets can be consolidated into fabrics via spunlacing, hydrolacing, needlepunching, or other processes which can generate a nonwoven sheet. The spunlaced processes disclosed in U.S. Pat. No. 3,508,308 and U.S. Pat. No. 3,797,074; and the needlepunching processes disclosed in U.S. Pat. No. 2,910,763 and U.S. Pat. No. 3,684,284 are examples of methods well-known in the art that are useful in the manufacture of the nonwoven fabrics. The preferred nonwoven fabrics of this invention are air-laid spunlaced or hydrolaced nonwovens where high pressure water jets are used to entangle fibers into a cohesive sheet.

Cellulose Fiber

Cellulose fiber useful in this invention is a char-forming cellulose fiber. By char-forming, it is meant the cellulose fiber retains at least 10 percent of its weight when heated in air to 700 C at a rate of 20 degrees C. per minute. Such cellulose fibers preferably have 10 percent inorganic compounds incorporated into the fibers. Such fibers, and methods for making such fibers, are generally disclosed in U.S. Pat. No. 3,565,749 and British Pat. No. GB 1,064,271. A preferred char-forming cellulose fiber for this invention is a viscose fiber containing silicon dioxide in the form of a polysilicic acid with aluminum silicate sites. Such fibers, and methods for making such fibers are generally disclosed in U.S. Pat. Nos. 5,417,752 and PCT Pat. Appl. WO 9217629. Viscose fiber containing silicic acid and having approximately 31 (+/−3) percent inorganic material is sold under the trademark Visil® by Sateri Oy Company of Finland. The char-forming fibers of this invention, when incorporated into the nonwoven fabric, provide adequate fire-blocking performance without the need for the fabric to be treated with additional flame-retardant additives or topically-applied flame retardant compounds.

Heat Resistant Fiber

The single layer nonwoven fabric contains a least 0.5 ounces per square yard of a heat resistant fiber and the fiber is preferably an organic fiber. By “heat resistant” it is meant that the fiber preferably retains 90 percent of its fiber weight when heated in air to 500 C at a rate of 20 degrees C. per minute. Such fibers are normally flame resistant, meaning the fiber or a fabric made from the fiber has a Limiting Oxygen Index (LOI) such that the fiber or fabric will not support a flame in air, the preferred LOI range being greater than 26. The preferred fibers do not excessively shrink when exposed to a flame, that is, the length of the fiber will not significantly shorten when exposed to flame. Fabrics containing 0.5 ounces per square yard (17 grams per square meter) of an organic fiber that retains 90 percent of its fiber weight when heated in air to 500 C at a rate of 20 degrees C. per minute tend to have limited amount of cracks and openings when burned by an impinging flame.

Heat resistant and stable fibers useful in the nonwoven fire-blocking fabric of this invention include fiber made from para-aramid, polybenzazole, polybenzimidazole, and polyimide polymer. The preferred heat resistant fiber is made from para-aramid polymer.

As used herein, “aramid” is meant a polyamide wherein at least 85% of the amide (—CONH—) linkages are attached directly to two aromatic rings. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the preferred para-aramid is poly(paraphenylene terephthalamide). Methods for making para-aramid fibers useful in this invention are generally disclosed in, for example, U.S. Pat. Nos. 3,869,430; 3,869,429; and 3,767,756. Such aromatic polyamide organic fibers and various forms of these fibers are available from DuPont Company, Wilmington, Del. under the trademark Kevlar® fibers.

Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, available from Toyobo, Japan. Commercially available polybenzimidazole fibers useful in this invention include PBI® fiber available from Celanese Acetate LLC. Commercially available polyimide fibers useful in this invention include P-84® fiber available from LaPlace Chemical.

Useful Combinations of Cellulos and Heat Resistant Fibers

One fire-blocking fabric useful in the fabric composite of this invention comprises at least 0.5 ounces per square yard (17 grams per square meter) of a viscose fiber containing silicic acid, and at least 0.5 ounces per square yard (17 grams per square meter) of a poly(paraphenylene terephthalamide fiber; the viscose fiber (X) and poly(paraphenylene terephthalamide) fiber (Y) being present in a weight ratio expressed by the equation:
Y>/=−0.14X+1.3

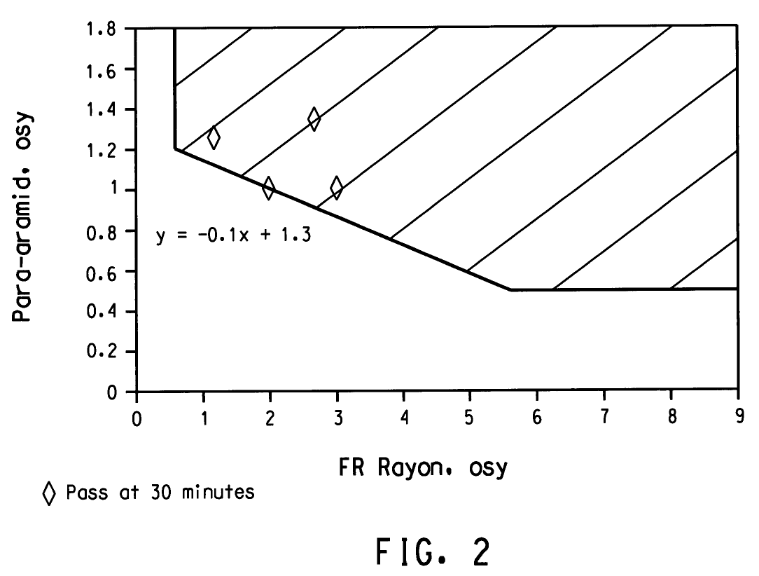

This area is represented by the area above the line in FIG. 2. Nonwoven fabric having the composition and the basis weights shown by this area can be used as a single layer as the sole fire-blocking component in the fabric composite, mattress and mattress set of this invention. Mattress sets that contain the fabric composite having the fire-blocking fabric so defined will have, when burned according to the California method, a peak heat release of less than 150 kilowatts within 30 minutes. This eliminates the need for multiple layers of fire-blocking fabrics that could add unacceptable bulk and/or stiffness to the mattress.

A more preferred fire-blocking fabric useful in the fabric composite of this invention will have a composition expressed by the equation:
Y>/=−0.14X+1.4

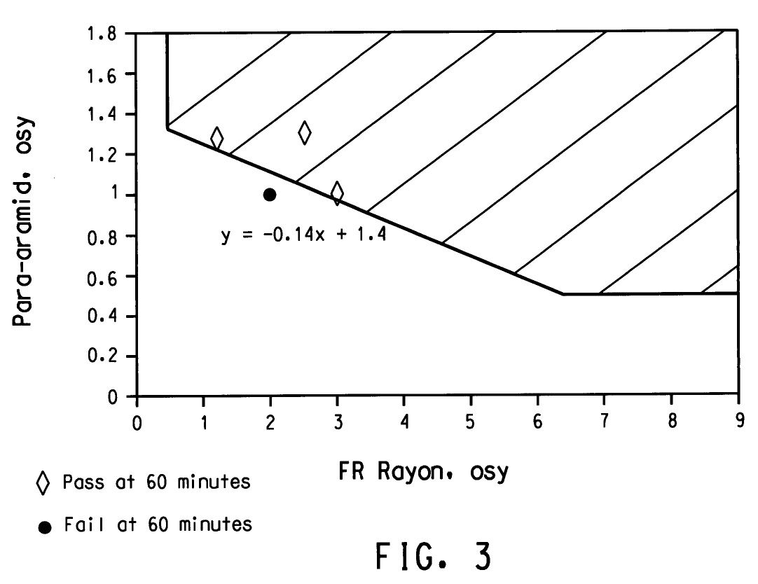

This area is represented by the area above the line in FIG. 3. Mattress sets that contain the fabric composite having the fire-blocking fabric so defined will have, when burned according to the California method, a peak heat release of less than 150 kilowatts within 60 minutes.

The nonwoven fire-blocking fabric used in this invention can include, in addition, an off gassing material that releases a flame suppressing gas when burned. The preferred off gassing material are fibers made from halogen-containing polymers, such as modacrylic fiber or polyvinylchloride fibers. These polymers release chlorine-containing gases when burned. Up to 4 ounces per square yard (136 grams per square meter) of such materials can be added to the single layer nonwoven fabric. Useful modacrylic fibers include, but are not limited to, those disclosed in U.S. Pat. No. 5,506,042.

Mattresses

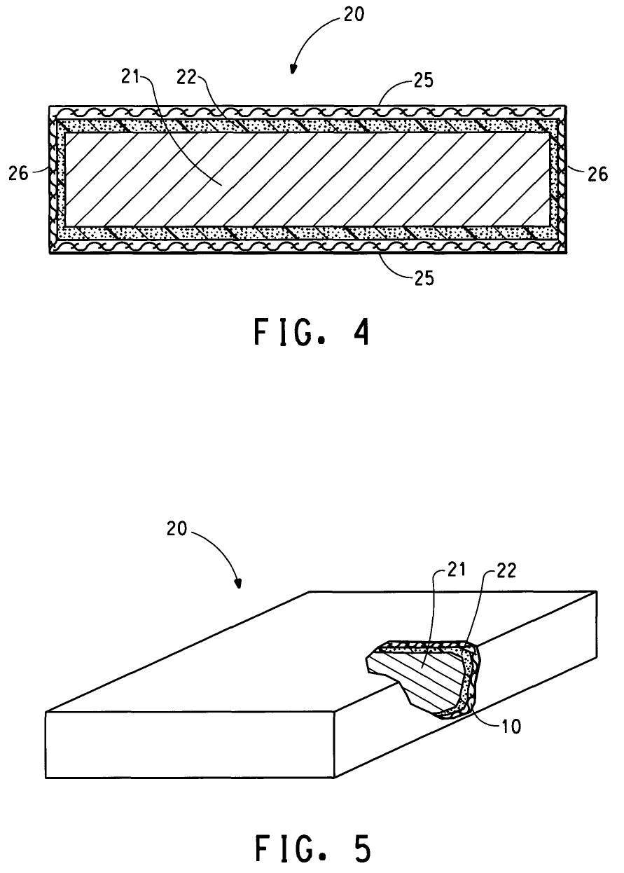

FIG. 4 is a simplified representation of a mattress of this invention, not drawn to scale for clarity. A cross section of mattress 20 is shown having the complete periphery covered by fabric composite 10. The top and bottom faces of the mattress, normally called the panels of the mattress, are designated by 25. The sides of the mattress, normally called the borders of the mattress, are designated by 26. Inside the fabric composite 10 is a layer of supporting foam 22, and in this case the supporting foam completely encases the mattress internals 21. FIG. 5 shows a cut-away view of mattress 20 with the fire-blocking fabric composite 10, supporting foam 22, and mattress internals 21.

For the purposes herein, the mattress core is meant to include any supporting foams 22 along with mattress internals 21. The mattress internals are intended to include the mechanical structure of the mattress, such as supporting beams and springs and associated wrappings. Such internals can also include additional foam, or combinations of foams and battings. The mattress core may also be only foam or other support materials, such as an air or liquid bladder with or without supporting foam, in the place of springs and other mechanical means of support.

Supporting foam 22 as discussed herein is a part of the mattress core and includes foams used to provide most of the support comfort of the mattress. Normally such foams cover only the panels of the mattress internals, however, the mattress internals may be totally enclosed. Fire-blocking of the mattress is done in large part to prevent the supporting foam from being ignited, or if the foam is ignited, to help suppress spread of the flame in the supporting foam.

The fabric composite of the this invention is useful to fire-block the panels and/or the borders of the mattress, and different amounts of cushioning material may be used in the borders versus the panel of the mattress. To totally fire-block the mattress the fire-blocking should be incorporated into all panels and borders of the mattress. This allows the mattress to be turned by the owner so that both sides of the mattress can be used, without losing any of the fire-blocking qualities.

Mattress Set

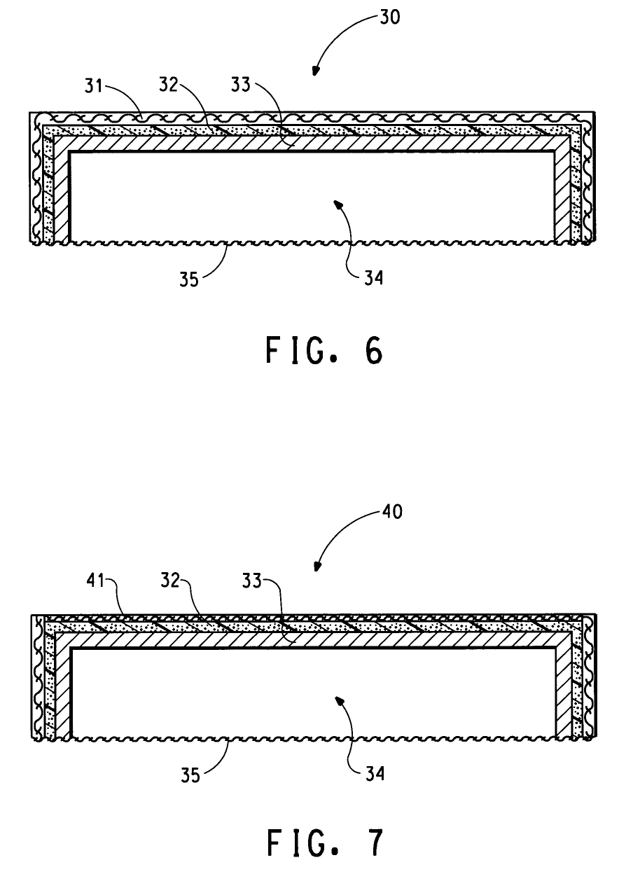

The fabric composite can also be used to fire-block a mattress set comprising a mattress and a mattress foundation. Foundations, such as box springs, are generally required to have fire-blocking on the borders or sides. The foundation top panel is normally in contact with the mattress and is somewhat shielded from flame so the material used in the foundation panel does not typically have to have the same degree of fire-blocking as say, the panel of the mattress. While not meant to be limiting, FIGS. 6 and 7 show a very simplified illustration of a type of foundation, a box spring, with two common types of fire-blocking arrangements. Referring to FIG. 6, box spring foundation 30 is covered on the top panel and all borders with fabric composite 31. Under the fabric composite is a layer of support foam 32. The support foam is attached to a support structure 33 that is normally made from wood or some other rigid material. In some cases there is a large open area 34 in the foundation that is covered on the bottom by a thin nonwoven fabric dust cover 35. An alternative arrangement is illustrated in FIG. 7. Mattress foundation 40 is covered on the top panel with an alternative top fabric 41 that is different from the fabric composite 31. This top fabric panel covers the top face while the fire-blocking is provided for all four borders to prevent the intrusion of the flame jet during the flammability testing. Because the top panel of the foundation is covered by the mattress, the top fabric panel need not be as flame retardant as the borders of the foundation. Further, the mattress foundation may not have a large degree of cushioning material in the border and/or the panel. It is sufficient to have a single layer fire-blocking fabric underneath the outer ticking in the mattress foundation border.

Mattress sets of this invention have a peak heat release of less than 150 kilowatts within the first 30 minutes of the test, and preferably within the first 60 minutes of the test, when tested according to this Technical Bulletin. Additionally, mattresses of this invention may have a total heat release of less than 25 megajoules within 10 minutes when tested according to this technical bulletin.

Process for Fire-Blocking Mattress

This invention is further directed to a process for fire-blocking a mattress by incorporating into the mattress a fire-blocking fabric between the cushioning material and the mattress core, the fire-blocking fabric being a single layer of nonwoven fabric comprising at least 0.5 ounces per square yard (17 grams per square meter) of a cellulose fiber that retains at least 10 percent of its fiber weight when heated in air to 700 C at a rate of 20 degrees C. per minute and at least 0.5 ounces per square yard (17 grams per square meter) of a heat-resistant fiber.

The fire-blocking fabric can be preferably incorporated into the mattress by first combining, in order, ticking fabric, cushioning material, and fire-blocking fabric into a fabric composite. The layers of the fabric composite can be stitched together and then the fabric composite can be used to cover the mattress core. The fabric composite can be attached to the mattress core by an appropriate means such as stitching. An alternate method of incorporating the fire-blocking fabric into the mattress is by placing individual layers of fire-blocking fabric, cushioning material, and ticking fabric on the mattress core and stitching the layers to the mattress core.

### Test Methods

Mattress Burn Performance

The Bureau of Home Furnishings and Thermal Insulation of the Department of Consumer Affairs of the State of California (3485 Orange Grove Avenue, North Highlands, Calif. 95660-5595, USA) published Technical Bulletin 603 “Requirements and Test Procedure for Resistance of a Residential Mattress/Box Spring Set to a Large Open-Flame” dated February 2003 to quantify the flammability performance of mattress sets. This protocol provides a means of determining the burning behavior of mattress/foundation sets by measuring specific fire test responses when the mattress plus foundation are exposed to a specified flaming ignition source under well-ventilated conditions. It is based on the National Institute of Standards and Technology Publication titled “Protocol of Testing Mattress/Foundation Sets Using a Pair of Gas Burners” dated February 2003.

Test data are obtained that describe the burning during and subsequent to the application of a specific pair of gas burners from the point of ignition until (1) all burning of the sleep set has stopped, (2) a period of one hour has elapsed, or (3) flashover of the test room appears inevitable. The rate of heat release from the burning test specimen (the energy generated by the fire) is measured by oxygen consumption calorimetry. A discussion of the principles, limitations, and requisite instrumentation are found in ASTM E 1590 “Standard Test Method of Fire Testing of Mattresses”. Terminology associated with the testing is defined in ASTM E 176 “Standard Terminology of Fire Standards”.

In general, the test protocal utilizes a pair of propane burners, designed to mimic the heat flux levels and durations imposed on a mattress and foundation by burning bedclothes. The burners impose differing fluxes for differing times on the mattress top and the side of the mattress/foundation. During and subsequent to this exposure, measurements are made of the time-dependent heat release rate from the test specimen.

The mattress/foundation is placed on top of a short bed frame that sits on a catch surface. During the testing, the smoke plume is caught by a hood that is instrumented to measure heat release rate. For practicality, twin-sized mattresses and foundations are tested. After ignition by the burners, the specimen is allowed to burn freely under well-ventilated conditions.

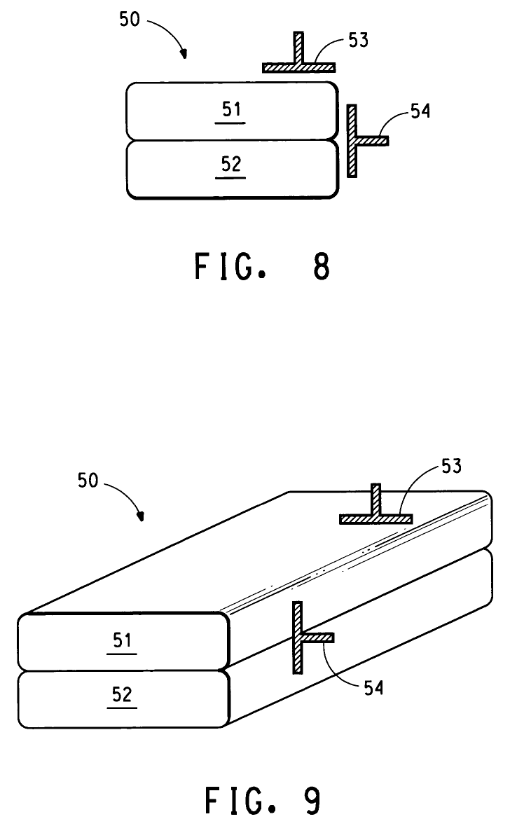

A representative illustration of the general locations of the gas burners, not drawn to scale, is shown in FIG. 8. Test specimen 50 includes a mattress 51 is placed on foundation 52 with T-shaped burners 53 and 54 set to burn the specimen. Burner 53 impinges flames on the top surface of the mattress and is set 39 mm from the surface of the mattress. The second burner 54 impinges flames vertically on the side of the mattress/foundation combination and is set 42 mm from the side of the specimen. The side burner and the top burner are not set at the same place along the length of the specimen but are offset from on another along the length approximately 18 to 20 cm as generally illustrated in FIG. 9. The burners are specially constructed and aligned per the test method.

The test specimen is conditioned for 24 hours prior to the testing at an ambient temperature of above 12 Celsius (54 Fahrenheit) and a relative humidity of less than 70 percent. The test specimen of mattress and foundation is centered on each other and the frame and catch surface. If the mattress is 1 to 2 cm narrower than the foundation the mattress may be shifted until the sides of the mattress and foundation are aligned vertically. The burners are aligned and spaced from the specimen per the standard. Data recording and logging devices are turned on at least one minute prior to ignition. The burners are ignited and the top burner is allowed to burn for 70 seconds while the side burner is allowed to burn for 50 seconds (if possible) and then they are removed from the area. Data collection continues until all signs of burning and smoldering have ceased or until one hour has elapsed.

ThermoGravametric Analysis

The fibers used in this invention retain a portion of their fiber weight when heated to high temperature at a specific heating rate. This fiber weight was measured using a Model 2950 Thermogravimetric Analyzer (TGA) available from TA Instruments (a division of Waters Corporation) of Newark, Delaware. The TGA gives a scan of sample weight loss versus increasing temperature. Using the TA Universal Analysis program, percent weight loss can be measured at any recorded temperature. The program profile consists of equilibrating the sample at 50 degrees C.; ramping the temperature at from 10 or 20 degrees C. per minute from 50 to 1000 degrees C.; using air as the gas, supplied at 10 ml/minute; and using a 500 microliter ceramic cup (PN 952018.910) sample container.

The testing procedure is as follows. The TGA was programmed using the TGA screen on the TA Systems 2900 Controller. The sample ID was entered and the planned temperature ramp program of 20 degrees per minute selected. The empty sample cup was tared using the tare function of the instrument. The fiber sample was cut into approximately 1/16″ (0.16 cm) lengths and the sample pan was loosely filled with the sample. The sample weight should be in the range of 10 to 50 mg. The TGA has a balance, therefore the exact weight does not have to be determined beforehand. None of the sample should be outside the pan. The filled sample pan was loaded onto the balance wire making sure the thermocouple is close to the top edge of the pan but not touching it. The furnace is raised over the pan and the TGA is started. Once the program is complete, the TGA will automatically lower the furnace, remove the sample pan, and go into a cool down mode. The TA Systems 2900 Universal Analysis program is then used to analyze and produce the TGA scan for percent weight loss over the range of temperatures.

### EXAMPLE 1

Three sleep sets, each comprised of a mattress and foundation, were made using typical mattress and box spring construction techniques, each set only differing in the type and basis weight of fire-blocking fabric used. The mattress core was a standard steel coil construction covered with a fiber pad and a 0.5 inch (1.25 centimeter) foam sheet. The foundation was a standard steel coil and wood box construction. All mattresses were a tight (smooth) top style. Table 1 lists the composition and basis weight of the fire-blocking fabric used in the five mattresses.

TABLE 1

| | | Basis w ight, | PHRR | PHRR | THR |
|---|---|---|---|---|---|
| Item | | oz/yd² | <150 kw | <150 kw | <25 MJ |
| No. | Composition | (g/m²) | 30 min | 60 min | 10 min |
| 1 | 50% Kevlar ®/ | 2.5 (85) | Pass | Pass | Pass |
| | 50% Visil ® | | | | |
| 2 | 33% Kevlar ®/ | 3.0 (102) | Pass | Fail | Pass |
| | 67% Visil ® | | | | |
| 3 | 25% Kevlar ®/ | 4.0 (136) | Pass | Pass | Pass |
| | 75% Visil ® | | | | |

PHRR—Peak Heat Release Rate
THR—Total Heat Release

Panel material for the mattresses was assembled by quilting together with standard polyester thread the following components in the order: 3.5 oz/yd² woven polyester ticking fabric, approximately 0.75″ polyester batting having an areal density of 0.75 oz/yd², a single layer fire-blocking fabric from Table 2, 1″ polyurethane foam sheet, 0.5″ polyurethane foam sheet, and a nonwoven backing sheet of approximately 1 oz/yd². The panel material was used to cover both sides (top and bottom) of the two-sided mattresses.

Border material was assembled in a separate operation by quilting together with standard polyester thread the following components in the order: 3.5 oz/yd² woven polyester ticking fabric, approximately 0.375″ polyurethane foam having an areal density of 2.5 oz/yd², the same fire-blocking fabric selected from Table 2 (same as used for the panel). The border material was used to cover all four vertical sides of the mattresses.

The border material was also used on the four vertical sides of the foundation employing a 2 inch (5.1 centimeter) continental or waterfall design on the upper edge of the foundation, a design in which the border material is folded over the upper edge and extends onto the foundation top panel.

The foundation top panel area within the continental edge was covered with a 4 oz/yd² (136 g/m²) of spunlaced nonwoven fabric (having a composition of 25% Kevlar® and 75% Visil®) under a standard non-skid pad. All border and panel composite material seams were sewed with a thread containing Keviar® fiber. FR-treated polyester seam tape was also used throughout.

The three sleep sets were individually burned according to Technical Bulletin 603 of the State of California. Burn results are summarized in Table 2. All had a Peak Heat Release Rate of less than 150 kilowatts in the first 30 minutes with a Total Heat Release of less than 25 megajoules in the first 10 minutes. Two of the mattresses also had a Peak Heat Release Rate of less than 150 kilowatts in the first 60 minutes.

### EXAMPLE 2

Two sleep sets, each comprised of a mattress and foundation, were made using the same techniques and materials as Example 1; however, a) the nonwoven fire-blocking fabric used in the mattress top panel and borders contained an off-gassing material that released a flame suppressing gas when burned and b) this nonwoven fire-blocking fabric was a single-layer needlepunched felt nonwoven fabric. The compositions and basis weights of these top panel fabrics are shown in Table 3. The bottom panels of the mattresses were made from the same material as the top panel of the foundation, that is the bottom panel was covered with a 4 oz/yd² (136 g/m²) of spunlaced nonwoven fabric (having a composition of 25% Kevlar® and 75% Visil®) under a standard non-skid pad.

Both sleep sets were burned as in Example 1 and both passed the Peak Heat Release Rate tests at both 30 and 60 minutes and the Total Heat Release test in the first 10 minutes.

TABLE 2

| | | Basis weight, | PHRR | PHRR | THR |
|---|---|---|---|---|---|
| Item | | oz/yd² | <150 kw | <150 kw | <25 MJ |
| No. | Composition | (g/m²) | 30 min | 60 min | 10 min |
| 1 | 20% Kevlar ®/ | 6.5 (220) | Pass | Pass | Pass |
| | 40% Visil ®/ | | | | |
| | 40% | | | | |
| | Modacrylic | | | | |
| 2 | 20% Kevlar ®/ | 6.5 (220) | Pass | Pass | Pass |
| | 40% Visil ®/ | | | | |
| | 40% Polyvinyl | | | | |
| | Chloride | | | | |

PHRR—Peak Heat Release Rate
THR—Total Heat Release

1. A fabric composite resistant to an open flame comprising in order:
(a) sacrificial outer ticking,
(b) sacrificial cushioning material, and
(c) fire-blocking fabric,
the fire-blocking fabric being a single layer of nonwoven fabric comprising at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per square meter) of a heat-resistant fiber.

2. The fabric composite of claim 1 wherein the outer ticking is a woven or knitted fabric having a basis weight of from 2 to 8 ounces per square yard (67 to 271 grams per meter).

3. The fabric composite of claim 1 wherein the cushioning material comprises a layer of fibers or a layer of foam or a combination of fiber and foam layers.

4. The fabric composite of claim 3 wherein the outer ticking and cushioning material are present in an amount that it has a total heat of combustion of from 5 to 130 megajoules per square yard (6 to 155 megajoules per square meter)

5. The fabric composite of claim 4 wherein the outer ticking and cushioning material have a total heat of combustion of less than 75 megajoules per square yard (90 megajoules per square meter).

6. The fabric composite of claim 5 wherein the outer ticking and cushioning material have a total heat of combustion of less than 30 megajoules per square yard (36 megajoules per square meter).

7. The fabric composite of claim 3 wherein the layer of fibers in the cushioning material is a batting of fibers, a vertically pleated arrangement of fibers, or a network of fibers.

8. The fabric composite of claim 3 wherein the cushioning material has a minimum thickness of at least ¼ inch (0.6 cm) and a maximum thickness of 3 inches (7.6 cm).

9. The fabric composite of claim 1 wherein the heat resistant fiber is an organic fiber that retains 90 percent of its fiber weight when heated in air to 500 C at a rate of 20 degrees C. per minute.

10. The fabric composite of claim 1 wherein the heat-resistant fiber comprises a para-aramid, polybenzazole, polybenzimidazole, or polyimide polymer.

11. The fabric composite of claim 10 wherein the para-aramid is poly(paraphenylene terephthalamide).

12. The fabric composite of claim 1 wherein the cellulose fiber is a viscose fiber containing silicic acid.

13. The fabric composite of claim 12 wherein the heat resistant fiber is a poly(paraphenylene terephthalamide) fiber and the viscose fiber (X) and heat resistant fiber (Y) being present in the fire-blocking fabric in a weight ratio expressed by the equation
Y>/=−0.14X+1.3

14. The fabric composite of claim 1 wherein the fire-blocking fabric further comprises an off gassing material that releases a flame suppressing gas when burned.

15. The fabric composite of claim 14 wherein the off gassing material is a modacrylic fiber.

16. The fabric composite of claim 14 wherein the off gassing material is a polyvinylchloride fiber.

17. A mattress resistant to an open flame comprising the fabric composite of claim 1.

18. The mattress of claim 17 wherein the fabric composite is located in a panel of the mattress.

19. The mattress of claim 17 wherein the fabric composite is located in a border of the mattress.

20. The mattress of claim 17 wherein the fabric composite further comprises seams having fire resistant thread stitching.

21. A mattress resistant to an open flame comprising the fabric composite of claim 9.

22. The mattress of claim 21 wherein the fabric composite is located in a panel of the mattress.

23. The mattress of claim 21 wherein the fabric composite is located in a border of the mattress.

24. The mattress of claim 21 wherein the fabric composite further comprises seams having fire resistant thread stitching.

25. A mattress resistant to open flame comprising the fabric composite of claim 13.

26. A mattress set resistance to an open flame comprising a mattress and a mattress foundation, said mattress set comprising the fabric composite of claim 1.

27. A mattress set resistance to an open flame comprising a mattress and a mattress foundation, said mattress set comprising the fabric composite of claim 9.

28. A mattress set resistance to an open flame comprising a mattress and a mattress foundation, said mattress set comprising the fabric composite of claim 13.

29. A mattress set resistant to an open flame comprising a mattress and a mattress foundation:
the mattress comprising a fabric composite and a mattress core, the fabric composite comprising in order:
(a) sacrificial outer ticking,
(b) sacrificial cushioning material, and
(c) a single layer nonwoven fire-blocking fabric,
the mattress foundation comprising a single layer nonwoven fire-blocking fabric and a support structure,
wherein the mattress set has a peak heat release rate of less than 150 kilowatts within 30 minutes and a total heat release of less than 25 megajoules in the first 10 minutes when tested according to Technical Bulletin 603 of the State of California.

30. The mattress set of claim 26 wherein the single layer nonwoven fire-blocking fabric comprises at least 0.5 ounces per square yard (17 grams per square meter) of a heat resistant fiber, the nonwoven fabric having a basis weight of at least 2.5 ounces per square yard (85 grams per square meter)

31. The mattress set of claim 27 wherein the heat resistant fiber is an organic fiber that retains 90 percent of its fiber weight when heated in air to 500 C at a rate of 20 degrees C. per minute.

32. The mattress set of claim 27 wherein the heat resistant fiber comprises a polymer selected from the group of para-aramid, polybenzazole, polybenzimidazole, and polyimide.

33. The mattress set of claim 27 wherein the heat resistant fiber is a poly(paraphenylene terephthalamide) fiber and the nonwoven fire-blocking layer includes a viscose fiber containing silicic acid, the viscose fiber (X) and heat resistant fiber (Y) being present in the fire-blocking fabric in a weight ratio expressed by the equation
Y>/=−0.14X+1.3

34. The mattress set of claim 18 wherein the mattress set has a peak heat release rate of less than 150 kilowatts within 60 minutes and a total heat release of less than 25 megajoules in the first 10 minutes when tested according to Technical Bulletin 603 of the State of California.

35. The mattress set of claim 31 wherein the single layer nonwoven fire-blocking fabric comprises at least 0.5 ounces per square yard (17 grams per square meter) of a heat resistant fiber, the nonwoven fabric having a basis weight of at least 2.5 ounces per square yard (85 grams per square meter).

36. The mattress set of claim 32 wherein the heat resistant fiber is an organic fiber that retains 90 percent of its fiber weight when heated in air to 500 C at a rate of 20 degrees C. per minute.

37. The mattress set of claim 32 wherein the heat resistant fiber comprises a polymer selected from the group of para-aramid, polybenzazole, polybenzimidazole, and polyimide.

38. The mattress set of claim 32 wherein the heat resistant fiber is a poly(paraphenylene terephthalamide) fiber and the nonwoven fire-blocking layer includes a viscose fiber containing silicic acid, the viscose fiber (X) and heat resistant fiber (Y) being present in the fire-blocking fabric in a weight ratio expressed by the equation
Y>/=−0.14X+1.4

39. A process for fire-blocking a mattress while retaining the aesthetics of the mattress cushioning material, the mattress having, in order, ticking, cushioning material, and a mattress core, the process comprising:
(a) incorporating into the mattress a fire-blocking fabric between the cushioning material and the mattress core,
(b) the fire-blocking fabric being a single layer of nonwoven fabric comprising at least 0.5 ounce per square yard (17 grams per square meter) of a cellulose fiber that retains at least 10 percent of its fiber weight when heated in air to 700 C at a rate of 20 degrees C. per minute and at least 0.5 ounces per square yard (17 grams per square meter) of a heat-resistant fiber.

40. The process of claim 34 wherein the heat resistant fiber is an organic fiber that retains 90 percent of its fiber weight when heated in air to 500 C at a rate of 20 degrees C. per minute.

41. The process of claim 34 wherein the heat-resistant fiber comprises a polymer selected from the group of para-aramid, polybenzazole, polybenzimidazole, and polyimide.

42. The process of claim 36 wherein the para-aramid is poly(paraphenylene terephthalamide).

43. The process of claim 34 wherein the heat resistant fiber is a poly(paraphenylene terephthalamide) fiber and the cellulose fiber is a viscose fiber containing silicic acid, the viscose fiber (X) and poly(paraphenylene terephthalamide) fiber (Y) being present in the fire-blocking fabric in a weight ratio expressed by the equation
Y>/=−0.14X+1.4

44. The process of claim 34 wherein the fire-blocking fabric further comprises an off gassing material that releases a flame suppressing gas when burned.
